(19) United States
(12) Patent Application Publication
(10) Pub. No.: US 2009/0227294 A1
(43) Pub. Date: Sep. 10, 2009

(54) ELECTRONIC APPARATUS

(75) Inventors: Natsuko Ouchi, Kawasaki-shi (JP); Kiyoshi Kagenaga, Chiba-shi (JP); Yoshiaki Otaki, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, TOKYO (JP)

(21) Appl. No.: 12/206,876

(22) Filed: Sep. 9, 2008

(30) Foreign Application Priority Data
Mar. 7, 2008 (JP) P2008-057421

(51) Int. Cl. H04Q 7/20

(52) U.S. Cl. 455/566

(57) ABSTRACT

According to one aspect of an electronic apparatus includes: a first display; a second display smaller in size than the first display; a determination section configured to determine whether or not there is notification information for a user; and a display control section configured to control the second display to display at least a PICT icon and a present time individually. The display control section controls the second display to prioritize a display of the PICT icon corresponding to the notification information to a display of the present time when the determination section determines that there is the notification information, and the display control section controls the second display to prioritize a display of the present time to a display of the PICT icon when the determination unit determines that there is no notification information.

The entire disclosure of Japanese Patent Application No. 2008-057421 filed on Mar. 7, 2008, including specification, claims, drawings and abstract is incorporated herein by reference in its entirety

### BACKGROUND

1. Field of the Invention

The invention relates to an electronic apparatus having a main display and a sub display to display information on the sub display based on priority according to whether or not there is notification information for a user.

2. Description of the Related Art

Recent mobile phones are advancing in multi-functionalization, and are further advancing in reduction in size, thickness, and weight. In these mobile phones, new small-size devices have been developed and employed to realize the reduction in size, thickness, and weight, without loss of various functions, which have ever been mounted thereon, as far as possible.

Particularly, in the recent mobile phones, when a foldable clamshell type is employed, generally, an accessorily used display (sub display) always exposed to the outside is mounted thereon to check information such as the present time and amount of remaining battery even at the time of carrying (folded state). However, to realize the reduction in size, thickness, and weight of the mobile phones, the display size of the sub display needs to be limited.

Thus, there has been proposed a mobile phone terminal (JP-A-2005-198172, for instance) that controls PICT display according to a shape of the terminal. In the mobile phone, a first casing and a second casing can be freely rotated and folded so that a first display section and a second display section are arranged in parallel, once the parallel arrangement of the first and second display sections is detected, PICT display on the first display section is automatically moved to the second display section, and then a display area of the first display section is utilized in a full size.

In the known mobile phone having a relatively small sub display mounted thereon, a utilization method or display information is limited, for example, information which can be displayed on the sub display is limited to only the present time. A user may choose a terminal having a large sub display in purchasing a mobile phone. However, in this case, user's satisfaction may not be fulfilled in view of size or the like. Accordingly, the user is under stress whether to set a high value on the condition of size or lightness of the sub display or to set a high value on the function of the sub display. A user choosing the mobile phone having the small-size sub display mounted thereon may have a problem that the user can check only limited information on the sub display.

### SUMMARY

According to one aspect of an electronic apparatus includes: a first display; a second display smaller in size than the first display; a determination section configured to determine whether or not there is notification information for a user; and a display control section configured to control the second display to display at least a PICT icon and a present time individually; wherein the display control section controls the second display to prioritize a display of the PICT icon corresponding to the notification information to a display of the present time when the determination section determines that there is the notification information, and the display control section controls the second display to prioritize a display of the present time to a display of the PICT icon when the determination unit determines that there is no notification information.

### BRIEF DESCRIPTION OF THE DRAWINGS

Embodiment may be described in detail with reference to the accompanying drawings, in which:

FIG. 1A is an exemplary front view showing an open state of an electronic apparatus according to an embodiment of the invention;

FIG. 1B is an exemplary side view showing an open state of the electronic apparatus;

FIG. 2A is an exemplary front view showing a close state of the electronic apparatus;

FIG. 2B is an exemplary side view showing a close state of the electronic apparatus;

FIG. 3 is an exemplary functional block diagram showing the electronic apparatus;

FIG. 4 is an exemplary PICT icon table showing kinds of PICT icons;

FIG. 5 is an exemplary table showing correspondence between status of the electronic apparatus and display information of a display;

FIG. 6 is an exemplary data configuration diagram showing priority information;

FIG. 7 is an exemplary flowchart showing a sequence when the electronic apparatus (mobile phone 1) performs a display control process of a sub display;

FIGS. 8A to 8C are picture diagrams showing an example of a display picture of the sub display; and

FIGS. 9A to 9C are picture diagrams showing an example of a display picture of the sub display.

### DETAILED DESCRIPTION OF THE EMBODIMENTS

An embodiment of an electronic apparatus according to the invention will be described with reference to the accompanying drawings. As the electronic apparatus according to the invention, a clamshell-type mobile phone 1 having a plurality of foldable casings will be described by way of example.

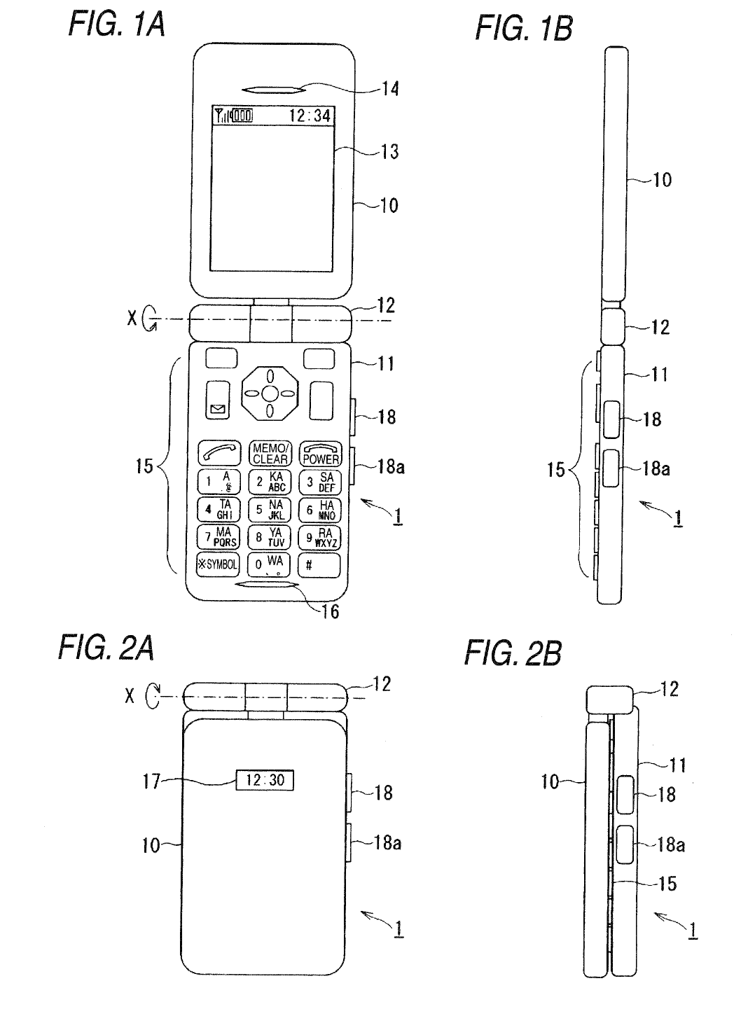

FIG. 1A is an exemplary front view showing an open state of the mobile phone 1, FIG. 1B is an exemplary side view showing the open state of the mobile phone 1, FIG. 2A is an exemplary front view showing a close state of the mobile phone 1, and FIG. 2B is an exemplary side view showing a close state of the mobile phone 1. As shown in FIGS. 1A, 1B, 2A and 2B, the mobile phone 1 includes an upper casing 10 having a rectangular plate shape and a lower casing 11 having substantially the same shape as the upper casing 10. The upper casing 10 and the lower casing 11 are folded to face each other in the close state. The upper casing 10 and the lower casing 11 are hinge-coupled by a hinge portion 12. The upper casing 10 is freely rotated with respect to the lower casing 11 by the hinge portion 12 as a shaft in a direction indicated by the arrow X shown in FIG. 1A by a predetermined angle. The mobile phone 1 is changed from the close state to the open state, or from the open state to the close state by rotating the upper casing 10 about the lower casing 11.

A display 13 for displaying display information including characters or images and a speaker 14 for outputting sound are provided on an inner face (opposed to the lower casing 11) of the upper casing 10. The display 13 and the speaker 14 are covered with the lower casing 11 and are not exposed to the outside when the mobile phone 1 is in the close state. However, the display 13 and the speaker 14 are exposed to the outside when the upper casing 10 is rotated with respect to the lower casing 11 to be changed to the open state.

For example, a power key for turning ON or OFF the power, a send key for phone call, and operation keys 15 formed of number pads for inputting numbers or characters are provided on an inner face (opposed to the upper casing 10) of the lower casing 11. A microphone 16 for collecting voice is provided on the inner face of the lower casing 11. The operation keys 15 and the microphone 16 are covered with the upper casing 10 and are not exposed to the outside when the mobile phone 1 is in the close state. However, the operation keys 15 and the microphone 16 are exposed to the outside when the upper casing 10 is rotated with respect to the lower casing 11 to be changed to the open state.

A sub display 17 smaller in size than the main display 13 to display the display information including characters or images is provided on an outer face (not opposed to the lower casing 11) of the upper casing 10. The sub display 17 is exposed to the outside independent of the open or close state of the mobile phone 1. Accordingly, a user can always view a display picture 50 displayed on the sub display 17.

Side keys are provided on the side face of the lower casing 11, for example, a start key 18 for starting the displaying on the sub display 17 and a switching key 18a for switching the display information displayed on the sub display 17. The side keys are always exposed to the outside independent of the open or close state of the mobile phone 1. Accordingly, the user may start the displaying on the sub display 17 or may switch the display information displayed on the sub display 17, by pressing the side keys.

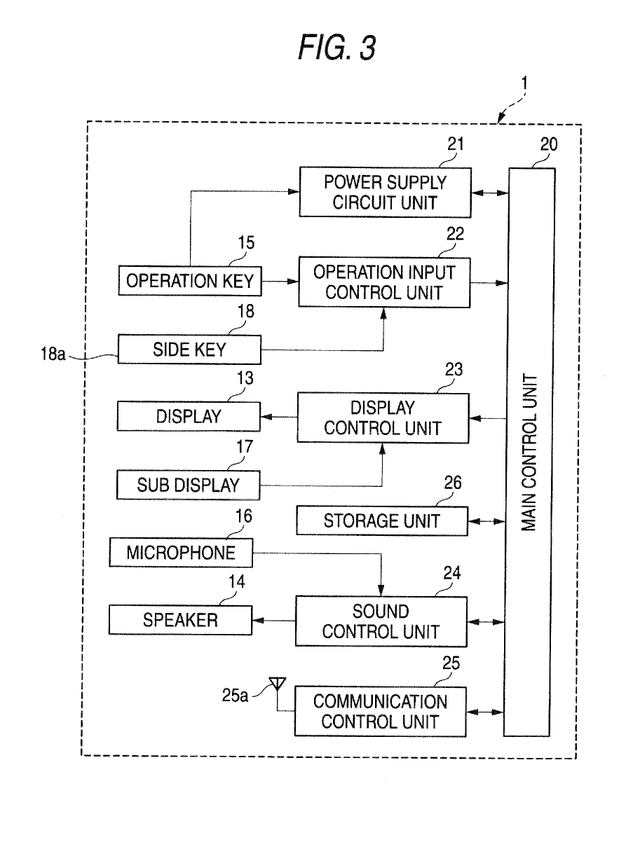

Next, functions of the mobile phone 1 will be described with reference to a functional block diagram shown in FIG. 3. As shown in FIG. 3, the mobile phone 1 includes a main control unit 20, a power supply circuit unit 21, an operation input control unit 22, a display control unit 23, a sound control unit 24, a communication control unit 25, and a storage unit 26, which are interconnected by a bus to communicate with each other.

The main control unit 20 has a Central Processing Unit (CPU), controls overall of the mobile phone 1, and performs a display control process of the sub display 17 and the other various operation processes. The power supply circuit unit 21 switches an ON/OFF state of the power supply based on an input from a user at the operation keys 15, and supplies power from a power supply source (battery, etc.) to each unit in the ON state of the power supply, thereby operating the mobile phone 1. The power supply circuit unit 21 transmits information representing the amount of remaining battery to the main control unit 20 based on the control unit of the main control unit 20. The main control unit 20 controls the storage unit 26 to store the information representing the amount of remaining battery.

The operation input control unit 22 has an input interface about the operation keys 15 and the side keys. When the operation input control unit 22 detects that the operation keys 15 or the side keys are pressed, the operation input control unit 22 generates a signal representing the pressed operation keys 15 or the side keys and transmits the signal to the main control unit 20. The display control unit 23 has a display interface about the display 13 or the sub display 17, and displays display information including characters or images on the display 13 or the sub display 17 based on the control of the main control unit 20.

The sound control unit 24 generates an analog sound signal from voice collected by the microphone 16 based on the control of the main control unit 20, and converts the analog sound signal into a digital sound signal. When the sound control unit 24 acquires the digital sound signal, the sound control unit 24 converts the digital sound signal into an analog sound signal and outputs the analog sound signal through the speaker 14 based on the control of the main control unit 20.

The communication control unit 25 performs a spectrum de-spread process on a received signal received from a base station (not shown) through an antenna 25a and restores data based on the control of the main control unit 20. According to an instruction of the main control unit 20, the data is transmitted to the sound control unit 24 and is output through the speaker 14, the data is transmitted to the display control unit 23 and is displayed on the display 13, or the data is stored in the storage unit 26. When the communication control unit 25 acquires the sound data collected by the microphone 16, the data input at the operation keys 15, or the data stored in the storage unit 26, based on the control of the main control unit 20, the communication control unit 25 performs a spectrum spread process on the data and transmits the data to the base station through the antenna 25a.

The communication control unit 25 transmits information representing a receive sensitivity of the antenna 25a to the main control unit 20 based on the control of the main control unit 20. The main control unit 20 stores information representing an electric field level in the storage unit 26 based on the receive sensitivity.

The storage unit 26 includes a Read Only Memory (ROM) for storing a process program or data necessary for the processes performed by the main control unit 20, a hard disk, a nonvolatile memory, and a Random Access Memory (RAM) for temporarily storing data used when the main control unit 20 performs the process, etc. The process program used when the main control unit 20 performs a display control process of the sub display 17 is stored, for example, in the ROM.

The storage unit 26 of ten stores information representing the amount of remaining battery of the mobile phone 1, information representing an electric field level, and information representing that there is an unread mail, a missed call, or a recorded voice mail.

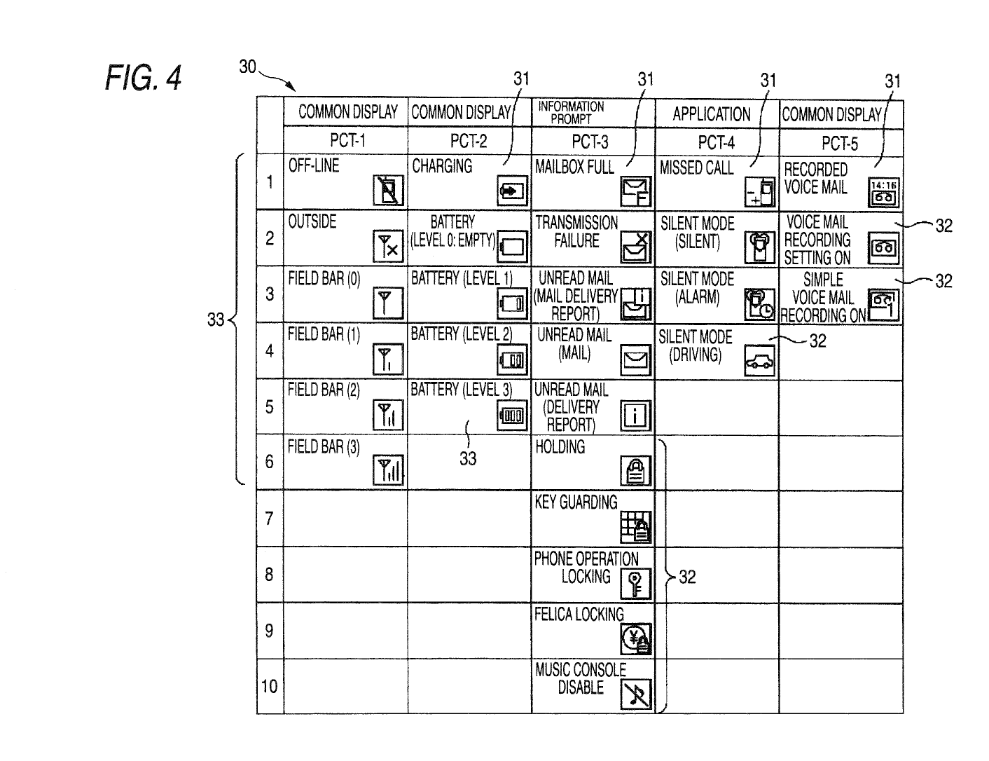

Normally, a PICT icon is displayed on the display 13 or the sub display 17. The PICT icon is an icon formed of a simple image, which represents a status of the mobile phone such as an electric intensity (electronic field bar) at an antenna and a battery level, or a setting status such as a silent mode. FIG. 4 shows a PICT icon table 30 representing kinds of PICT icons.

For example, as shown in FIG. 4, PICT icons are divided into five groups of PICT-1 to PICT-5. The group of PICT-1 includes a PICT icon representing off-line, a PICT icon representing out of service, and a PICT icon representing an electric field bar, etc. In the PICT icon representing the electric intensity, the number (0 to 3) of bars indicates intensity of electric field. The group of PICT-2 includes a PICT icon representing charging, and a PICT icon representing a battery level, etc. In the PICT icon representing the battery level, the number (0 to 3) of bars indicates a level of the amount of remaining battery.

The group of PICT-3 includes a PICT icon representing a status that the mobile phone cannot receive a mail because there is no empty region of the memory, a PICT icon representing mail transmission failure, a PICT icon representing that there is an unread mail, a PICT icon representing holding, a PICT icon representing key guarding, a PICT icon representing operation locking, a PICT icon representing Felica (trademark) locking, and a PICT icon representing that a music console as an application program is disable, etc.

The group of PICT-4 includes a PICT icon representing that there is a missed call, and a PICT icon representing a silent mode, etc. As the silent mode, for example, there are a normal silent mode, an alarm mode, and a driving mode. The group of PICT 5 includes a PICT icon representing that there is a recorded message (voice mail) in a service center, a PICT icon representing that a voice mail recording setting of an application program operated by the mobile phone 1 is ON, and a PICT icon representing that a simple voice mail recording setting of an application program operated by the mobile phone 1 is ON, etc.

In the PICT icons, as shown in FIG. 4, there are PICT icons 31 dealt with as “Notification Information”, PICT icons 32 dealt with as “o Notification Information”, and PICT icons 33 having no relation with notification information. For example, in the mobile phone 1, when there is information independent of user's operation, in case of reception of a mail or a missed call, for instance, the user needs to be notified as the notification information. Accordingly, when there is information representing that there is an unread mail or a missed call, the status is “Notification Information”. Meanwhile, when there is information representing that a silent mode is ON, the information is information operated and set by the user and the user needs not to be notified. Accordingly, the status is “No Notification Information”.

The information dealt with as “Notification Information” independent of the user's operation, notifies states where a mailbox is full; a mail transmission is failed; an unread email exists; a missed call exists and a recorded voice mail is exists in a service center, etc. The information dealt with as “No Notification Information” depending on the user's operation, includes holding, key guarding, operation locking, Felica (trade mark) locking, music console running, etc. The information having no relation with the notification information includes off-line, out of service, an intensity of electric field, charging, and a battery level, etc.

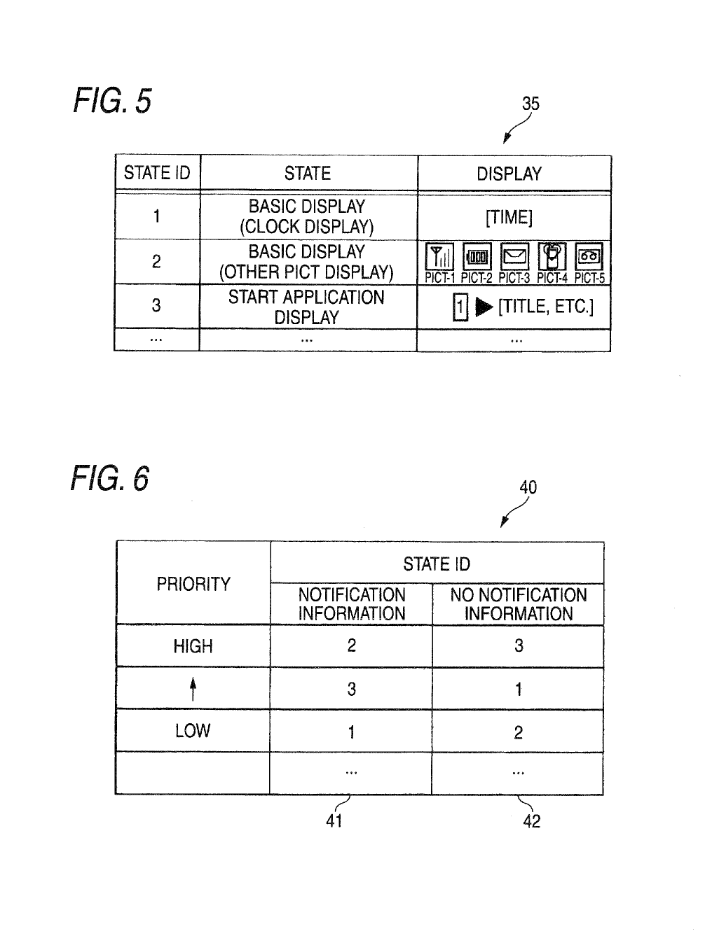

For example, when a user presses the side key such as the start key 18, the mobile phone 1 starts the displaying on the sub display 17. At this time, any one of a plurality piece of information is displayed on the sub display 17. As shown a state-display corresponding table 35 in FIG. 5, clock display with state ID of “1”, PICT display on PICT icons with state ID of “2”, and running application display for an application program for running a music console with state ID of “3” are performed. In the clock display, the information independent of the user's operation is displayed. In the PICT display, information depending on the user's operation and information independent of the user's operation are displayed. In the running application display, the information about the application program run depending on the user's operation is displayed.

In the PICT display with state ID of “2”, there are provided display areas corresponding to the groups of PICT-1 to PICT-5, and at most one PICT icon is selectively displayed on each display area. For example, as shown in FIG. 5, an electrical field intensity (three bars) is displayed in the display area of PICT-1, a battery (level 3) is displayed in the display area of PICT-2, an unread mail is displayed in the display area of PICT-3, a silent mode is displayed in the display area of PICT-4, and information representing that there is a voice mail recording is displayed in the display area of PICT-5. In the groups of PICT, when there are a plurality of information to be displayed, one PICT icon shown in the upper part of the PICT icon table 30 is selected and displayed. In the PICT groups of PICT, when there is no information to be displayed, the display area thereof is displayed as a blank.

The storage unit 26 of the mobile phone 1 stores priority information 40 representing priority in display on the sub display 17 with respect to the display states shown in FIG. 5. As shown in FIG. 6, the priority information 40 includes priority information 41 representing priority in the case of “Notification Information” and priority information 42 representing priority in the case of “No Notification Information”. As described above, in the mobile phone 1, the priority of the display information displayed on the sub display 17 is determined according to whether or not there is notification information.

For example, according to the priority information 40 shown in FIG. 6, in the case of “Notification Information”, the PICT display with state ID of “2”, the running application with state ID of “3”, and the clock display with state ID of “1” are displayed on the sub display 17 of the mobile phone 1 in order of priority. In the case of “No Notification Information”, the running application with state ID of “3”, the clock display with state ID of “1”, and the PICT display with state ID of “2” displayed in order of priority.

That is, in the mobile phone 1, when there is notification information generated without user's operation at the time of the displaying on the sub display 17, that is, when there is notification information such as an unread mail, a missed call, and a recorded message in a service center, the user needs to be notified of the content thereof. Accordingly, it is information such as the present time. It is prior to notify the user of the notification information. For example, when the mobile phone 1 receives a new mail and the user does not read the received mail, the notification of the mail reception has the highest priority. At this time, when the mobile phone 1 is playing a music, the display information about the playing music has the next highest priority.

When there is no notification information in the mobile phone 1, only the information set by the user is displayed such as a silent mode and an operating locking in the PICT display. Accordingly, priority of the PICT display is low. Therefore, when the application program such as the music reproducing is operated in the mobile phone 1, the information about the application program has the highest priority. Then, the clock display has the next highest priority.

When the switching of the display information is instructed by pressing a predetermined side key (e.g., switching key 18a) by a user while displaying information on the sub display 17, the mobile phone 1 switches the display information of the sub display 17 based on the priority represented by the priority information 40.

As described above, in the mobile phone 1, even when the sub display 17 mounted on the mobile phone 1 has the small size and thus a large amount of information cannot be displayed at once, the user can check the most necessary information with the simple key operation by displaying the information having the highest priority to notify the user. In addition, in the mobile phone 1, the user can check various kinds of information with the simple key operation by switching the display content based on the instruction by pressing the side key by the user.

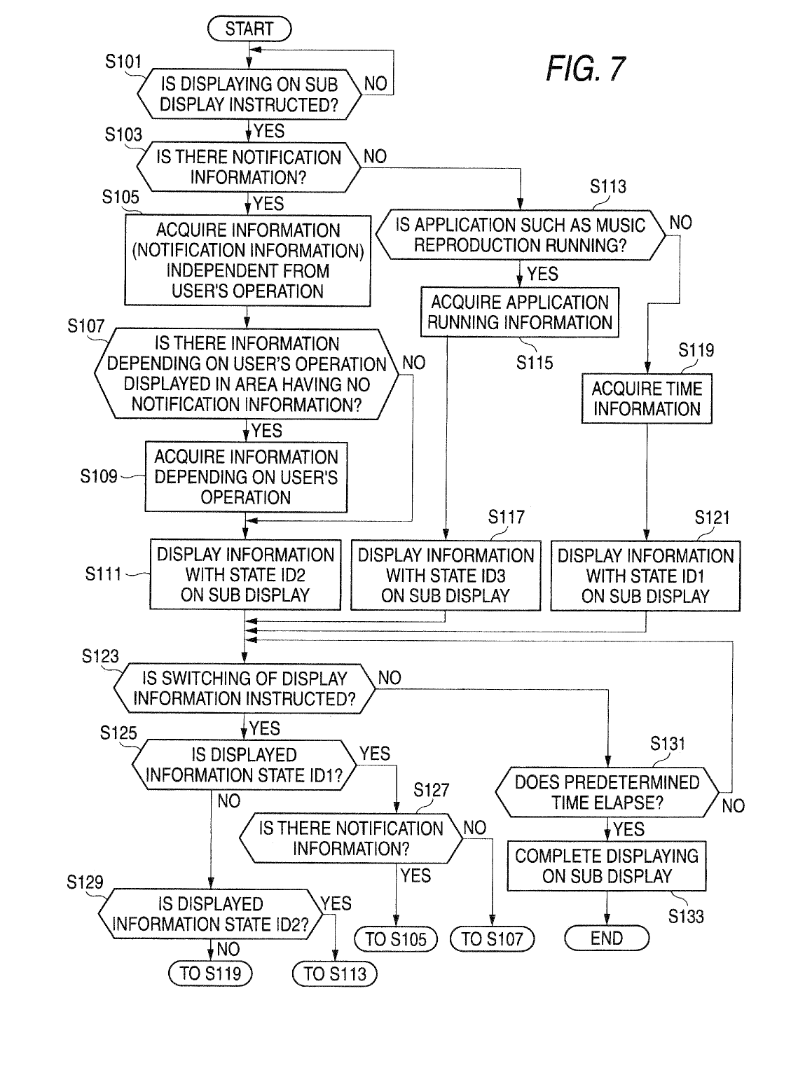

The mobile phone 1 performs a display control process of the display picture 50 of the sub display 17 based on the priority information 40 stored in the storage unit 26 at the time of instructing the displaying on the sub display 17. A sequence of the display control process performed by the mobile phone 1 will be described with reference to a flowchart shown in FIG. 7. Hereinafter, for example, “Step S101” is referred to as “S101” for description by omitting “Step”. In addition, in the mobile phone 1, it is assumed that the application program for playing music is running, and all of hold, operation locking, a silent mode, a voice mail recording setting, and simple voice rail recording setting are OFF.

A user instructs the mobile phone 1 to display information on the sub display 17 by pressing, for example, the start key 18. The main control unit 20 determines whether or not the displaying on the sub display 17 is instructed (S101) In this case, it is determined that the displaying on the sub display 17 is instructed by pressing the side key by the user or by changing the mobile phone 1 from the open state to the close state. When the displaying on the sub display 17 is not instructed (S101:No), the main control unit 20 waits in that state.

When the displaying on the sub display 17 is instructed (S101:Yes), the main control unit 20 determines whether or not there is notification information notifies, for example, a mailbox is full; a mail transmission is failed; an unread email exists; a missed call exists and a recorded voice mail is exists (S103).

When there is the notification information (S103:Yes) the main control unit 20 acquires information independent of user's operation (notification information) from the storage unit 26 (S105). That is, the main control unit 20 acquires information about PICT display with state ID of “2” having the highest priority based on the priority information 41 when there is the notification information of the priority information 40.

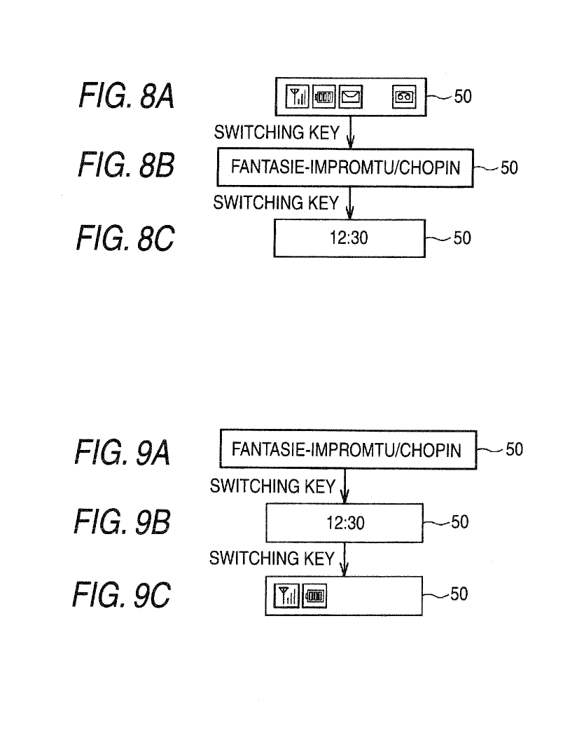

The main control unit 20 determines whether or not there is information to be displayed on the display area having no notification information (S107) For example, when there is notification information of an unread mail and recorded voice mail in the mobile phone 1 a PICT icon representing an unread mail is displayed in the display area of PICT-3, and a PICT icon representing a voice mail message in the service center is displayed in the display area of PICT-5, as shown in FIG. 8A. At this time, there is no notification information in the display areas of PICT-1, PICT-2, and PICT-4. Accordingly, the main control unit 20 determines whether or not there is information to be displayed for the groups of PICT-1, PICT-2, and PICT-4.

When there is information to be displayed in the display area having no notification information (S107:Yes), the main control unit 20 acquires information (information other than notification information) depending on user's operation from the storage unit 26 with respect to the display areas (S109). For example, the main control unit 20 acquires an electric field bar to be displayed in the display area of PICT-1 and a battery level to be displayed in the display area of PICT-2. As for PICT-4, when a silent mode is set, the main control unit 20 acquires information representing that the silent mode is ON.

After the process of Step S109 is completed, or when there is no information to be displayed in the display area having no notification information (S107:No), the main control unit 20 displays the information with state ID of “2” on the sub display 17 (S111). For example, as shown in FIG. 8A, based on the information acquired in Step S105 or S109, a PICT icon representing an electric field bar (three bars) is displayed on the display area of PICT-1, a PICT icon representing a battery (level 3) is displayed on the display area of PICT-2, a PICT icon representing an unread mail is displayed on the display area of PICT-3, and a PICT icon representing a voice mail message in the service center is displayed on the display area of PICT-5. In the group of PICT-4, since there is no notification information and the other information to be displayed, the display area of PICT-4 remains as a blank.

When there is no notification information (S103:No), the main control unit 20 determines whether or not an application program for music reproducing is running (S113). When the application program is running (S113:Yes), the main control unit 20 acquires information about the application program (S115). That is, the main control unit 20 acquires information about running application display with state ID of “3” having the highest priority based on the priority information 42 in the case that there is no notification information of the priority information 40. For example, when the application program for music reproducing is running, information about the reproducing music is acquired, as shown in FIG. 9A.

The main control unit 20 displays information with state ID of “3” on the sub display 17 (S117) For example, as shown in FIG. 9A, information of “FANTASIE—IMPROMTU/CHOPIN” which is the playing music is displayed based on the information acquired in Step S115.

When the application program is not running (S113:No), the main control unit 20 acquires time information representing the present time (S119). That is, the main control unit 20 acquires information about time display with state ID of “1” having the next highest priority based on the priority information 42 in the case that there is no notification information of the priority information 40. Then, the main control unit 20 displays the information with state ID of “1” on the sub display 17 (S121). For example, as shown in FIG. 9B, information of “12:30” as the present time is displayed based on the information acquired in Step S119.

The main control unit 20 determines whether or not the display information is instructed to be switched (S123). In this case, it is determined that the display information is instructed to be switched, by pressing the side key of the switching key 18a by the user.

When the display information is instructed to be switched (S123:Yes), the main control unit 20 determines whether or not the displayed information is the information about the time display with state ID of “1” (S125). When the displayed information is the information about the time display with state ID of “1” (S125:Yes), the main control unit 20 determines whether or not there is notification information in the mobile phone 1 (S127). The determination is performed in the same sequence as Step S103.

When there is the notification information (S127:Yes), the process returns to Step S105, and the main control unit 20 acquires the notification information from the storage unit 26. In Step S111, the main control unit 20 displays the information about PICT display on the sub display 17 as shown in FIG. 8A, from the state shown in FIG. 8C. When there is no notification information (S127:No), the process returns to Step S107. The main control unit 20 determines whether or not there is information depending on user's operation displayed in the display having no notification information. In Step S111, the main control unit 20 displays the information about PICT display on the sub display 17 as shown in FIG. 9C, from the state shown in FIG. 9B. In this case, since there is no notification information and the other information to be displayed in the display areas of PICT-3 to PICT-5, the display areas of PICT-3 to PICT-5 remains as a blank.

When the displayed information is not the information about the time display with state ID of “1” (S125:No), the main control unit 20 determines whether or not the displayed information is information about PICT display with state ID of “2” (S129) When the displayed information is the information about the PICT display with state ID of “2” (S129:Yes), the process returns to Step S113 and the main control unit 20 determines whether or not the application program is running. When the application program is running, the information about the running application display on the sub display 17 as shown in FIG. 8B or FIG. 9A, from the state shown in FIG. 8A or FIG. 9C, in Step S117.

When the displayed information is not the information about the PICT display with state ID of “2” (S129:No), that is, when the displayed information is the information about the running application display with state ID of “3”, the process returns to Step S119 and the main control unit 20 acquires time information. In Step S121, the main control unit 20 displays the information about the time display on the sub display 17 as shown in FIG. 8C or FIG. 9B, from the state shown in FIG. 8B or FIG. 9A.

That is, when there is notification information in the mobile phone 1, the display information is switched in an order of state ID of “2”, “3”, “1”, and “2” every when pressing the side key based on the priority information 41 in the case that there is the notification information of the priority information 40. When there is no notification information in the mobile phone 1, the display information is switched in an order of state ID of “3”, “1”, “2”, and “3” every when pressing the side key based on the priority information 42 in the case that there is no notification information of the priority information 40.

When the display information in not instructed to be switched (S123:No), the main control unit 20 determines whether or not a predetermine time (e.g., 10 seconds) elapses (S131). The predetermined time is a time previously stored in the storage unit 26. The predetermined time may be lapse of time after starting the displaying on the sub display 17 in Steps S111, S117, and S121, and may be lapse of time after the side key such as the start key 18 and the switching key 18a is finally pressed by the user.

When the predetermined time does not elapse (S131:No), the process returns to Step S123. The main control unit 20 determines whether or not the display information is instructed to be switched. When the predetermined time elapses (S131:Yes), the main control unit 20 completes the displaying on the sub display 17 (S133).

As described above, in the mobile phone 1, when the displaying on the sub display 17 is instructed by the user, the information to be firstly displayed on the sub display 17 is selected based on the priority information 40. When the switching of the sub display 17 is instructed by the user, the display content of the sub display 17 is switched based on the priority information 40. Accordingly, the user can check various kinds of Information such as the present time and the notification information in the state where the mobile phone 1 is close, in order of priority according to whether or not there is notification information.

The mobile phone 1 according to the invention has the sub display 17, the information having high priority according to the status of the mobile phone 1 is displayed on the sub display 17, and the display information is switched by a simple operation (e.g., key pressing). Therefore, even when the sub display 17 has a relatively small size, it is possible to display the optimum information by supposing information necessary for a user.

The display picture 50 of the sub display 17 may be displayed in a telop manner. In this case, the display information of the sub display 17 is not switched by pressing the side key, but the display information may be sequentially displayed by the telop manner. The telop display manner may be that the display information is displayed in the sequence based on the priority information 40. The range for switching the display in the telop manner may be the whole sub display 17. Alternatively, the PICT icons of electric field and battery are always displayed, and only the area for displaying the other PICT may be displayed in the telop manner.

Generally, when the user checks information using the sub display 17, the user wants to check the present time or the running application information. When there is an unread mail or a missed call in the mobile phone 1, it is preferable that the user can check the notification information representing the unread mail or the missed call by the sub display 17. In the mobile phone 1 of the invention, when there is notification information, the notification information is displayed with priority. When there is no notification information, the present time or the running application information is displayed with priority. Accordingly, when the there is the notification information, the user can promptly check the notification information. When the notification information is not displayed, the user can judge that there is no notification information. Therefore, it is possible to skip a work that the user conforms whether or not there is notification information.

In the embodiment, it is described that the PICT icons representing the electrical bar or the battery level is basically displayed by way of example, but the invention is not limited thereto. These PICT icons may not be displayed but only the other information may be displayed. Considering that there are a lot of information to be notified, the reason is that necessary information can be displayed using the whole display area of the sub display 17 by displaying the other information in the display area for these PICT icons.

The displaying on the sub display 17 may be switched with the lapse of time. In the embodiment, at the time of switching, a state firstly displayed based on priority at the time of starting the displaying is determined, and then the displaying is switched by pressing the side key. However, even when the side is not pressed, the displaying may be automatically switched with the lapse of predetermined time.

When there are a lot of information, the mobile phone 1 may have the user check the main display 13 by displaying “Please check information” on the display picture 50 of the sub display 17. In the embodiment, there is described the method for displaying a lot of information on the display picture 50 of the sub display 17. However, when the user checks notification information, the user checks the notification information on the main display 13. Accordingly, when there is information such as an unread mail or a missed call, a massage such as “Please check unidentified information” maybe displayed on the sub display 17. In this method, the present time may be displayed for a predetermined time after starting the displaying on the sub display 17, and then the massage may be displayed to have the user conform the main display 13, or the display picture 50 of the sub display 17 may be displayed in the telop manner, which may be combined with each other.

Accordingly, even when there is few information that can be displayed on the sub display 17 at once, information that the user wants to check with the highest priority is displayed with the first priority. With respect to the other information, it is possible to display much information by switching the picture displaying with a simple operation (key pressing).

In the embodiment, the mobile phone 1 is described by way of example. However, the invention is not limited thereto, and the invention may be applied to any electronic apparatus having a sub display, such as a Personal Handyphone System (PHS), a Personal Digital Assistants (PDA), a digital camera, a video camera, a potable audio, and a portable video.

What is claimed is:

1. An electronic apparatus comprising:
a first display;
a second display smaller in size than the first display;
a determination section configured to determine whether or not there is notification information for a user; and
a display control section configured to control the second display to display at least a PICT icon and a present time individually;
wherein the display control section controls the second display to prioritize a display of the PICT icon corresponding to the notification information to a display of the present time when the determination section determines that there is the notification information, and the display control section controls the second display to prioritize a display of the present time to a display of the PICT icon when the determination unit determines that there is no notification information.

2. An electronic apparatus comprising:
a first display;
a second display smaller in size than the first display;
a determination section configured to determine whether or not there is notification information for a user; and
a display control section configured to control the second display to display at least a PICT icon and information about a running application program individually;
wherein the display control section controls the second display to prioritize a display of the PICT icon corresponding to the notification information to a display of the information about the running application program when the determination unit determines that there is the notification information, and the display control section controls the second display to prioritize a display of the information about the running application program to a display of the PICT icon when the determination unit determines that there is no notification information.

3. The apparatus according to claim 1, further comprising an input section;
wherein, when an instruction for switching display information on the second display is input at the input section, the display control section switches the display information on the second display.

4. The apparatus according to claim 2, further comprising an input section;
wherein, when an instruction for switching display information on the second display is input at the input section, the display control section switches the display information on the second display.

5. The apparatus according to claim 1, wherein the notification information includes information independent from the user's operation.

6. The apparatus according to claim 2, wherein the notification information includes information independent from the user's operation.

7. The apparatus according to claim 5, wherein the notification information notifies any one of states where a mailbox is full; a mail transmission is failed; an unread email exists; a missed call exists and a recorded voicemail is exists.

8. The apparatus according to claim 6, wherein the notification information notifies any one of states where a mailbox is full; a mail transmission is failed; an unread email exists; a missed call exists and a recorded voicemail is exists.
